(19) United States
(12) Patent Application Publication
(10) Pub. No.: US 2013/0247828 A1
(43) Pub. Date: Sep. 26, 2013

(54) HEATING AND/OR COOLING BED

(71) Applicants: Denise Tedaldi, Danvers, MA (US); Laryssa Chortyk White, Salem, MA (US); Melissa Marshall, Gloucester, MA (US)

(72) Inventors: Denise Tedaldi, Danvers, MA (US); Laryssa Chortyk White, Salem, MA (US); Melissa Marshall, Gloucester, MA (US)

(73) Assignee: PetEdge, Inc., Beverly, MA (US)

(21) Appl. No.: 13/430,375

(22) Filed: Mar. 26, 2012

(51) Int. Cl. A01K 29/00

(52) U.S. Cl. 119/28.5

(57) ABSTRACT

Exemplary embodiments of the present disclosure include a pet cooling/heating bed having a base portion and a top portion. The base portion can include an outer shell defining a cavity. A fill material can be disposed within the cavity of the outer shell to provide a pillow-like structure. The top portion can be detachably fastened to the base portion, and can include a compartment defining an interior area. Embodiments of the pet bed can also include a thermal pack insert and a fastening device. The thermal pack insert can be dimensioned and configured to fit within the interior area defined by the compartment to provide a surface area on the top portion to cool or heat a pet. The fastening device can detachably fasten the top portion to the base portion.

### BACKGROUND

Exemplary embodiments relate to pet beds, and more particularly to pet beds for providing a cooled and/or heated surface upon which a pet can rest.

Pet beds are typically developed and marketed to pet owners who wish to provide a comfortable surface for their pets to rest. In some instances, however, the pet beds may not provide such a comfortable environment. For example, pet beds may cause the pet to be too warm or conversely may not provide sufficient warmth to the pet depending on several factors, including the ambient temperature of the environment, the material used to form the bed, the pet's coat, and so on.

### SUMMARY

Exemplary embodiments of the present disclosure are directed to a pet cooling and/or heating bed for indoor and/or outdoor use. Embodiments of the pet bed can include a base portion and a detachable top portion that can be secured to the base portion. The top portion includes one or more compartments within which one or more thermal pack inserts can be removably disposed. In exemplary embodiments, the top portion can be detached from the base portion so that the top portion and the base portion can be cleaned, washed, and/or used separately. Embodiments of the pet bed can be made from durable materials and at least portions of the pet bed can be made or coated with a water resistant or water proof material.

In one embodiment, a pet bed including a base portion, top portion, and thermal insert pack is disclosed. The base portion includes an outer shell defining a cavity and a fill material disposed within the cavity of the outer shell. The top portion is detachably fastened to the base portion. The top portion includes a closable compartment defining an interior area and the thermal pack insert is configured to fit within the interior area defined by the compartment and to heat, cool, and/or maintain a temperature and/or a range of temperatures associated with the top portion.

In another embodiment, a pet bed including a base portion, top portion, and fastening device is disclosed. The base portion has first and second surfaces and at least one side surface extending between the first and second surfaces to form a cavity within which a fill material is disposed. The top portion is detachably fastened to the first surface and has third and fourth surfaces. A compartment is disposed between the third and fourth surfaces for receiving a thermal pack insert. A fastening device fastens the top portion to the first surface of the base portion.

Other objects and features will become apparent from the following detailed description considered in conjunction with the accompanying drawings, wherein like reference numerals identify like elements. It is to be understood, however, that the drawings are designed as an illustration only and not as a definition of the limits of the invention.

### BRIEF DESCRIPTION OF THE DRAWINGS

FIG. 1 shows a cross-sectional view of an exemplary pet bed having a base portion and a detachable top portion within which a thermal pack insert can be inserted.

FIG. 2 shows an exemplary top view of the pet bed with the top portion attached to the base portion.

FIG. 3 shows an exemplary side view of the pet bed with the top portion attached to the base portion.

FIG. 4 shows an exemplary bottom view of the pet bed.

FIG. 5 shows a perspective view of the pet bed with the top portion attached to the base portion.

FIGS. 6A and 6B show a perspective view of the pet bed in which the top portion of the pet bed is partially and fully detached from a base portion of the pet bed, respectively.

FIG. 7 shows a thermal pack insert insertable into the top portion of the pet bed.

FIG. 8 shows another exemplary pet bed for providing a cooled and/or heated surface upon which a pet can rest.

FIG. 9 shows another exemplary pet bed for providing a cooled and/or heated surface upon which a pet can rest.

### DETAILED DESCRIPTION OF EXEMPLARY EMBODIMENTS

Exemplary embodiments of the present disclosure include a pet bed for providing a cooling and/or heating affect to a pet, such as a dog, cat, or other domesticated animal. The pet bed can include a base portion and a top portion that can be detachably fastened to the base portion. The top portion can include a closable compartment for receiving a thermal pack insert, which can be cooled or heated before insertion into the compartment. Once the cooled or heated thermal pack insert has been inserted into the compartment, the top portion of the pet bed can provide a cooled or heated area upon which a pet can rest.

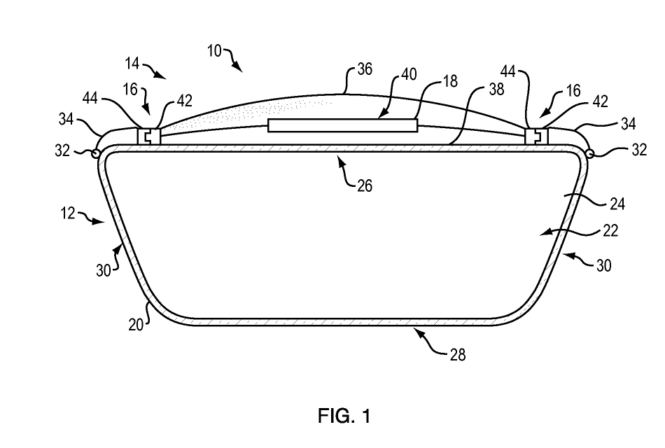

FIG. 1 is a cross-sectional view of an exemplary pet bed 10. The exemplary pet bed 10 includes a base portion 12, a top portion 14, a fastening device 16, and a thermal pack insert 18. The top portion 14 can be detachably fastened to the base portion 12 by the fastening device 16 such that the top portion 14 can be attached to and detached from the base portion 12 allowing the base portion 12 and/or the top portion 14 to be used, washed, and/or cleaned separately. The pet bed 10 can provide a cushioned pillow-like or mattress-like support surface upon which a pet or a portion of the pet can rest. At least a portion of the support surface can be cooled, warmed, and/or maintained at a temperature and/or a temperature using the thermal pack insert 18 that can be removably disposed within the top portion 14.

Still referring to FIG. 1, the base portion 12 can include, for example, an outer shell 20 that forms a cavity 22 within which a fill material 24 can be disposed. The base portion 12 can provide a supporting structure for the top portion 14 and can provide a pillow-like or mattress-like body to provide a cushioned surface on which a pet can rest. The outer shell 20 can include a first surface 26, a second surface 28, and side surfaces 30 extending between the first and second surfaces 26 and 28, respectively, such that the first surface 26, second surface 28, and the side surfaces 30 define the cavity 22. The first and second surfaces 26 and 28 can form generally parallel planar surfaces extending between the side surfaces 30 when the cavity 22 is filled with the fill material 24 and the base portion 12 is uncompressed, for example, under the weight of a pet. The outer shell 20 can have a generally rectangular or trapezoidal cross-sectional shape when the cavity 22 is filled with the fill material 24. The first surface 26 can provide a surface upon which a pet can rest when the base portion 12 is used separately from the top portion 14 and can provide a supporting surface to the top portion 14 when the base portion 12 and the top portion 14 are used together. The second surface 28 provides a surface that rests on a supporting surface, such as, for example, a floor.

The outer shell 20 can be formed of a water resistant or water proof material and/or can be coated with a water resistant or water proof coating. In exemplary embodiments, the outer shell 20 can be formed using a polymer-based material, such as nylon, which can be coated with water resistant material, such as a Teflon coating, to make the outer shell 20, or a portion thereof, resistant to water. For example, the outer shell 20 can be formed by Teflon coated Nylon from DuPont so that the base portion is suitable for outdoor use and can be rinsed clean with water.

The fill material 24 can be used to form the cushioned pillow-like or mattress-like body of the base portion 12 to aid in retention of the shape of the base portion 12 and/or to provide a cushioned surface upon which a pet can rest. Some examples of a fill material 24 can include one or more of foams, battings, gels, water, and the like. Foams can include, for example, a foam material with an open cell structure, such as a polyester and/or polyurethane foam, and/or a foam material with a closed cell structure, such as layers of Neoprene foam. Batting can include, for example, one or more sheets of polyester or a blended polyester material. In an exemplary embodiment, the fill material 24 can be Poly-Fill.

Piping 32 can be disposed along an upper edge of the side surfaces 30 forming a boundary between the first surface 26 and the side surfaces 30. The piping 32 can be sewn or otherwise disposed in or on the outer shell 20 and can provide structural support to the base portion 12. For example, the piping 32 can be formed from a material, such as nylon tubing, that is resilient and/or flexible so that the piping 32, at least in part, can resiliently retain the shape of the base portion 12 along one or more dimensions of the base portion 12.

In exemplary embodiments, a connecting material 34 can extend from the base portion 12. For example, the connecting member 34 can be disposed on the first surface extending inward from the piping 32 to provide an area for connecting the top portion 14 to the base portion 12. The connecting material 34 can be fastened to the top portion 14 by the fastening device 16. In exemplary embodiments, the connecting member can form a flap having one end attached to the base portion at the piping 32 and having a free end configured to be fastened to the top portion 14. In exemplary embodiments, the connecting material 34 can be formed of a different material than that of the base portion 12. In exemplary embodiments, the connecting material 34 and the top portion 14 can be formed of the same material.

Still referring to FIG. 1, the top portion 14 can include a first surface 36 connected to or continuously formed with a second surface 38. The top portion 14 can be dimensioned to mate with the connecting material 34 of the base portion 12 such that when the top portion 14 is fastened to the base portion 12, the first surface 36 of the top portion 14 and the connecting material 34 form an upper surface of the bed 10 upon which a pet can rest. The top portion 14 can substantially overlay the first surface 26 of the base portion 12. When the top portion 14 is attached to the base portion 12, the second surface 38 of the top portion 14 is positioned adjacently to the first surface 26 such that the surfaces 38 and 26 are proximate to and face each other.

In exemplary embodiments, the top portion 14 can be formed of a porous structure, such as a mesh, to facilitate air circulation in the top portion 14. One or more layers of material can be used to form the first surface 36 and/or the second surface 38. In some embodiments, the porous structure can be formed as a meshed material or materials, which can be referred to herein as “air mesh”, and which facilitates air circulation through at least one of the surfaces 36, 38 of the top portion 14. In some embodiments, the first surface 36 and/or the second surface 38 can be formed of Nylon, polyester, or any other suitable material or materials.

The closable compartment 40 can be sandwiched between first and second surfaces 36 and 38, respectively, of the top portion 14 such that the first and second surfaces 36 and 38 can encase the closable compartment 40. In exemplary embodiments, the compartment 40 can be a sleeve sewn into the top portion 14 to form a hidden pocket within the top portion 14 having an opening at a first end and being closed at a second end. The compartment 40 can be configured to receive and retain the pack insert 18. In exemplary embodiments, the compartment 40 can be lined with polyester.

The fastening device 16 can detachably fasten the top portion 14 and the base portion 12 such that the top portion 14 can be fastened to or detached from the base portion 12. A first portion 42 of the fastening device 16 can be disposed on the connecting material 34 of the base portion 12 and a second portion 44 of the fastening device 16 can be disposed on the top portion 14. The first and second portions 42 and 44 of the fastening device 16 can mate to detachably fasten the top portion 14 to the base portion 12. In exemplary embodiments, the fastening device 16 can include a zipper, buttons, snaps, a loop and hook fastener (e.g., Velcro), and the like.

The thermal pack insert 18 can be formed using one or more thermal materials having thermal properties that can facilitate a generally slow temperature rise or fall after being cooled or heated, respectively, until temperature equilibrium is reached with a surrounding environment. Some examples of thermal materials include for example, water, Blue Ice® from Rubbermaid, a refrigerant gel, grains (e.g., oats, flax seed, wheat), and the like. In exemplary embodiments, the thermal material can include a mixture of water and hydroxyethyl cellulose or silica gel to form a gel pack and/or can include propylene glycol.

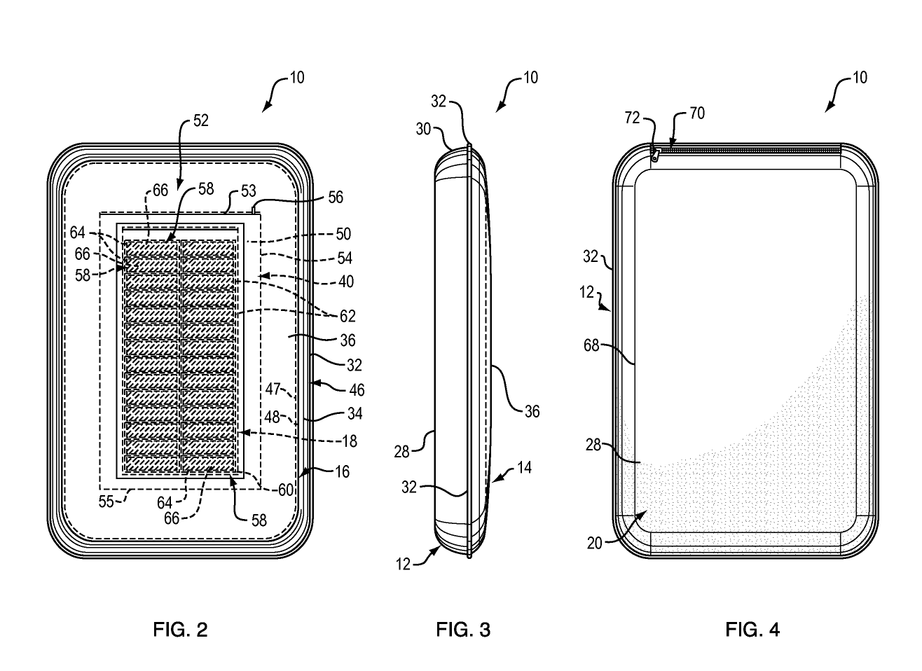

FIGS. 2-4 show a top, side, and bottom view of the pet bed 10, respectively, with the top portion 14 attached to the base portion 12. The piping 32 defines a perimeter 46 of the first surface (obscured) of the base portion (obscured) and the connecting member 34 forms a frame-like structure extending inward from the perimeter 46 to an inner perimeter 47. A perimeter 48 of the top portion 14 fits within the inner perimeter 47 of the frame-like structure formed by the connecting member 34 to facilitate attachment of the top portion 14 to the connecting member 34 via the fastening device 16.

As shown in phantom in FIG. 2, the top portion 14 of the pet bed 10 includes the closable compartment 40 disposed therein having an interior area 50 for receiving the thermal pack insert 18 (shown in phantom in FIG. 2). The interior area 50 of the compartment 40 can be defined by a sleeve lined with polyester and can be accessed through an opening 52 at a first end 53 of the compartment 40, which is formed in the first surface 36 of the top portion 14, and a closed second end 55. The opening 52 can be dimensioned to permit insertion of the thermal pack insert 18 into the compartment 40 and removal of the thermal pack insert 18 from the compartment 40. For example, the opening 52 can be formed as a slit in the first surface 36 having a width that is wider than a width of the thermal pack insert 18.

In the present embodiment, the interior area 50 can have a generally rectangular configuration having a perimeter 54 that is smaller than the perimeter 48 associated with the top portion 14. The interior area 50 defined by the compartment 40 can be configured to generally conform to the size and shape of the thermal pack insert 18 such that when the pack insert 18 is inserted into the compartment 40, the thermal pack insert 18 generally occupies the interior area 48 of the compartment 40 to generally fix the position of the thermal pack insert 18 with respect to the surfaces 36 and 38.

A closure device 56 can be disposed along the opening 52 to facilitate closing and opening of the compartment 40. Some exemplary closure devices can include a zipper, buttons, snaps, a loop and hook fastener (e.g., Velcro), and the like. In the present embodiment, a zipper can be used to implement the closure device 56. Although the closable opening 52 is formed in the first surface 36 of the top portion 14, those skilled in the art will recognize that the opening 52 can be disposed in other locations. As one example, the opening 52 can be disposed in the second surface 38 such that the opening 52 is not visible when the top portion 14 is attached to the base portion 12 and the top portion 14 would have to be at least partially detached to access the compartment 40. As another example, the opening 52 can be formed along a portion of the perimeter 48 of the top portion 14 between the first and second surfaces 36 and 38.

In exemplary embodiments, the compartment 40 can be centrally or substantially centrally positioned in the top portion 14. Positioning the compartment 40 centrally in the top portion 14 can align the compartment 40 with the pet's core (e.g. torso region) so that when the pet rests on the pet bed 10 with a cooled or heated pack insert 18 disposed therein, a transfer of thermal energy between the pet's core and the pack insert 18 can occur to provide efficient and effective cooling or heating of the pet.

The thermal pack insert 18 can include one or more reusable thermal packs 58 encapsulated by a membrane 60. In some embodiments, the thermal pack insert 18 can be a single thermal pack 58 such that the thermal pack insert 18 and the thermal pack 58 are one and the same. The membrane 60 can be formed of a puncture resistant material that facilitates cooling or heating disbursement, such as a nylon ripstop material. In the present embodiment, the pack insert 18 includes a quantity of separate thermal packs 58 that are each sewn into or otherwise disposed in the membrane 60 such that the thermal packs 58 and the membrane 60 form the pack insert 18. The thermal packs 58 can be permanently and/or removably disposed within the membrane 60. The thermal packs 58 can be disposed in the membrane 60 such that the membrane 60 can be partitioned into segments 62, where each of the segments 62 can include at least one of the thermal packs 58. By partitioning the membrane 60 into segments 62, the thermal pack insert 18 can be flexible despite any rigidity of the individual thermal packs 58, such as, for example, when the thermal packs 58 are frozen. In exemplary embodiments, the thermal packs 58 can have a membrane 64 with a reusable thermal material 66 disposed therein. The thermal material 66 can have thermal properties that facilitate a generally slow temperature rise or fall after being cooled or heated, respectively, until temperature equilibrium is reached with its surrounding environment.

As shown in FIG. 3, the side surfaces 30 of the base portion 12 can extend between the piping 32 and the second surface 28 in a generally curved or rounded manner. The second surface 28 can form a generally flat surface to form a contact area between the bed 10 and a supporting surface, such as a floor. The first surface 36 of the top portion 14 can form a slightly convex protrusion that can be compressed towards the base portion 12 under the weight of a pet.

As shown in FIG. 4, a perimeter 68 of the second surface 28 can be smaller than the perimeter 46 of the first surface 26 such that the base portion 12 narrows from the first surface 26 to the second surface 28 to form a generally trapezoidal body. An opening 70 can be formed in the outer shell 20 to permit access to the cavity 22 (FIG. 1). For example, the fill material 24 can be inserted and/or removed from the cavity 22 via the opening 70. In exemplary embodiments, the opening 70 can be formed in one of the side surfaces 30 of the outer shell 20 proximate to and under the piping 32. The opening 70 can be closed by a closure device 72, such as a zipper, hook and loop fastener (e.g., Velcro), buttons, snaps, and the like, and can be covered so that the opening 72 is not visible or is mostly obscured when it is closed.

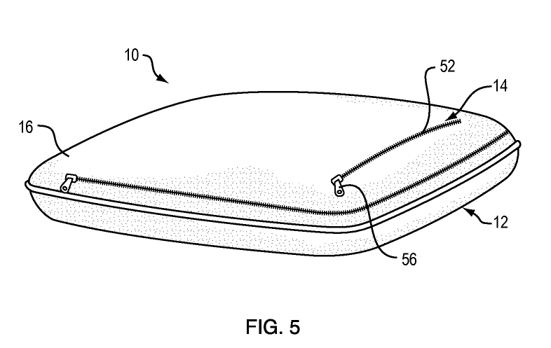

FIG. 5 shows an exemplary perspective view of the pet bed 10 in which the top portion 14 is fastened to the base portion 12 by the fastening device 16. As shown in FIG. 5, the pet bed 10 can have a generally rectangular or trapezoidal elongate body. The compartment (obstructed) can be accessed via the closable opening 52, which can be opened or closed using the closure device 56. The pet bed 10 can be dimensioned to accommodate different sized animals. For example, the pet bed 10 can be dimensioned for small, medium, and/or large sized pets. While the pet bed 10 has been illustrated as being generally rectangular or trapezoidal, those skilled in the art will recognize that the pet bed 10 can be any other shape. In exemplary embodiments, the pet bed can be, for example, circular, square, oval, hexagonal, octagonal, kidney shaped, and the like.

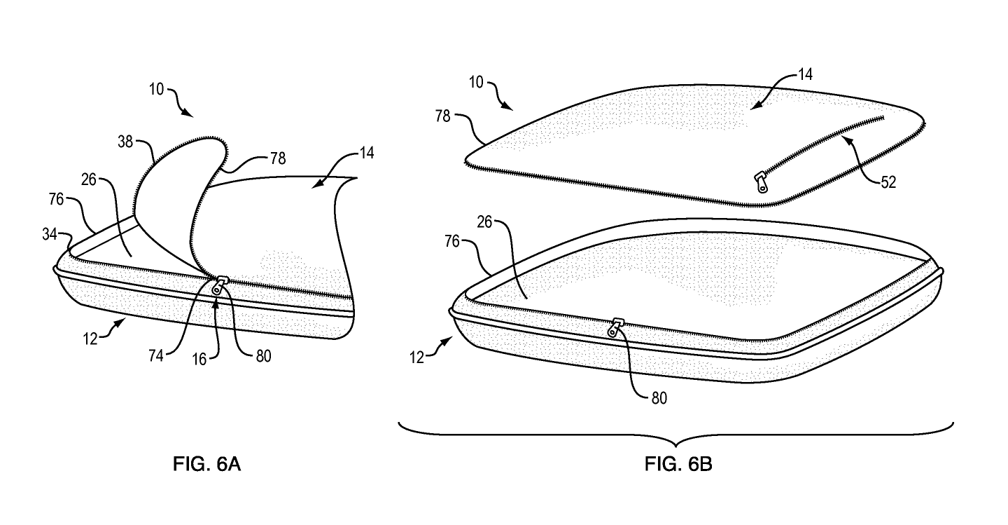

FIG. 6 shows a perspective view of the pet bed 10 with the top portion 14 partially and completely detached from the base portion 12. When the top portion 14 completely detached from the base portion 12, the base portion 12 and/or the top portion 14 can be separately washed in a washing machine, rinsed with water, or otherwise cleaned. Likewise, when the base portion 12 and the top portion 14 are completely detached, the base portion 12 and/or the top portion 14 can be used independently of each other. In the present embodiment, for example, the fastening device 16 is a zipper assembly 74 including a first set of teeth 76 coupled to the connecting material 34 and extending about a perimeter 48 of the top portion 14, a second set of teeth 78 coupled to and extending about inwardly facing end of the connecting material 34, and a sliding tab 80 moveably attached to the second set of teeth 78 to interlock the second set of teeth 78 to the first set of teeth 76.

To fasten the top portion 14 to the base portion 12 the sliding tab 80 aligns and interlocks the second set of teeth 78 to the first set of teeth 76 by sliding in a first direction. To detach the top portion 14 from the base portion 12, the sliding tab 80 is slid in an opposite direction to disengage the first and second sets of teeth 76 and 78. When the zipper assembly 74 is fully zipped, the top portion 14 is secured to the base portion 12, and the surfaces 26 and 38 can be inaccessible.

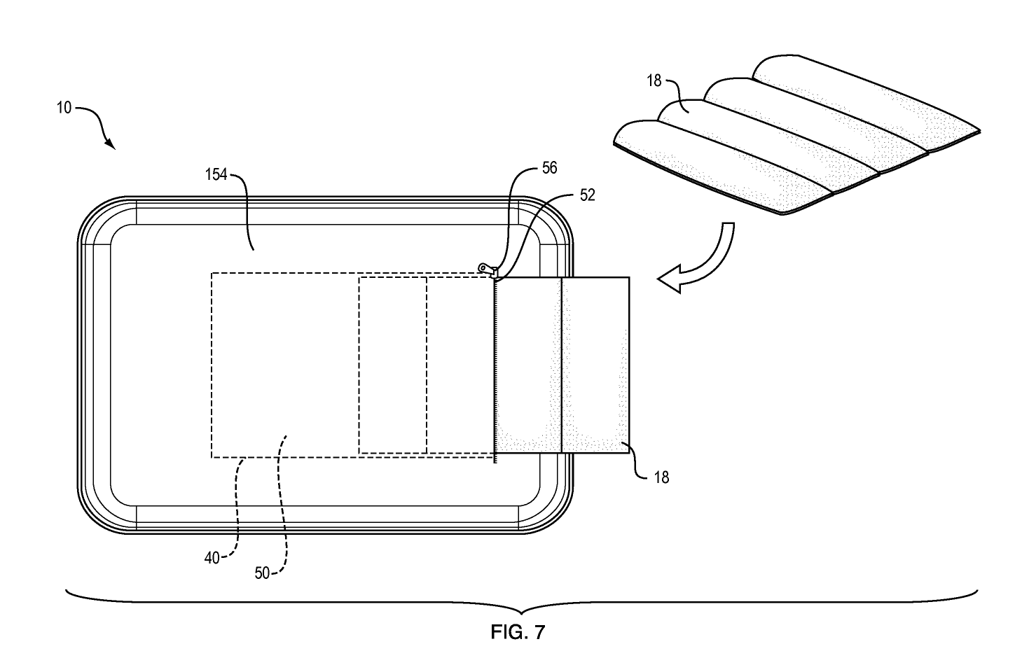

FIG. 7 shows the thermal pack insert 18 being inserted into the top portion 14 of the pet bed 10. To insert the thermal pack insert 18 into the compartment 40, the closure device 56 is moved to the open position so that the opening 52 permits access to the interior area 50 of the compartment 40. The thermal pack insert 18 slides through the opening 52 until it is fully retained within the compartment 40. Once the thermal pack insert 18 is inserted into the compartment 40, the closure device 56 is moved to the closed position to close the opening 52 and prevent access to the interior area 50 of the compartment 40. The thermal pack insert 18 can be removed from the compartment 40 by moving the closure device 56 to the open position to open the opening 52 and permit access to the interior area 50 of the compartment 40.

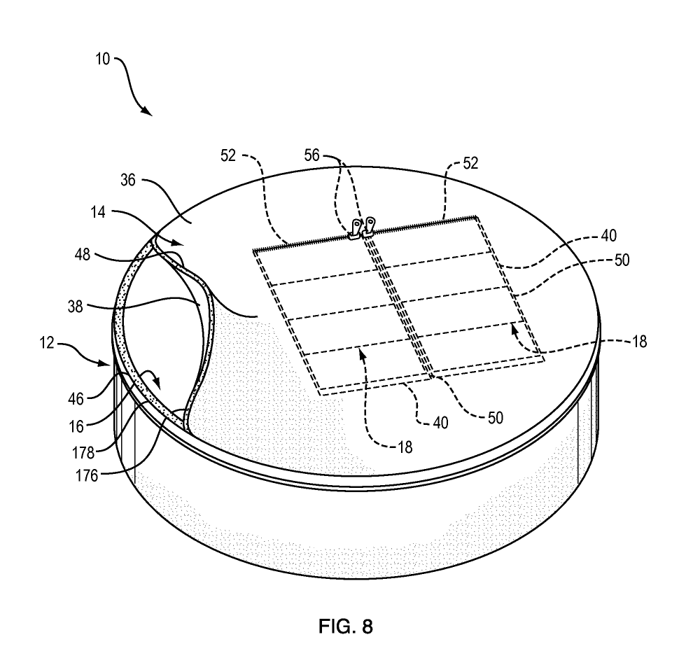

FIG. 8 shows another exemplary pet bed 10 for providing a cooled and/or heated surface upon which a pet can rest. The pet bed 10 can include the base portion 12, the top portion 14, the fastening device 16, and two pack inserts 18. In exemplary embodiments, the pet bed 10 can have a generally circular configuration and can be dimensioned to accommodate different sized animals. For example, the pet bed 10 can be dimensioned for small, medium, and/or large sized pets. While the pet bed 10 has been illustrated as being circular, those skilled in the art will recognize that the pet bed 10 can be implemented using other shapes, such as rectangular, square, oval, hexagonal, octagonal, kidney shaped, and the like.

The top portion 14 can have a generally circular configuration including the first and second surfaces 36 and 38. The top portion 14 can include at least two compartments 40 disposed therein, each having corresponding interior areas 50 for receiving one of the pack inserts 18. The compartments 40 can be disposed between the first and second surfaces 36 and 38 of the top portion 14. The closure devices 56 can be disposed along the openings 52 to facilitate closing and opening of the compartments 40. In the present embodiment, a Velcro can be used to implement the closure devices 56. When the top portion 14 is fastened to the base portion 12 the openings 52 on the second surface 38 are not visible and/or can be inaccessible such that the top portion 14 has to be at least partially detached from the base portion 12 to access the compartments 40.

The interior areas 50 can be positioned in the top portion 14 to provide one or more areas for receiving the thermal pack inserts 18 to facilitate cooling and/or heating. As one example, the interior areas 50 can be placed side-by-side such that the interior areas 50 form a substantially single area, which can be centrally positioned in the top portion 14 or can be offset from the center of the top portion 14. As another example, the interior areas 50 can be spaced apart in the top portion 14 such that the interior areas 50 can form separate areas of cooling and/or heating.

In the present embodiment, the fastening device 16 is Velcro including one or more loop elements 176 coupled to and extending about the perimeter 48 of the top portion 14, one or more hook elements 178 coupled to and extending about the perimeter 46 of the first surface 26. To fasten the top portion 14 to the base portion 12, the loop and hook elements 176 and 178, respectively, are aligned and pressed together. To detach the top portion 14 from the base portion 12, the top portion 14 can be pulled apart from the base portion 12 with a force that overcomes the binding force of the Velcro.

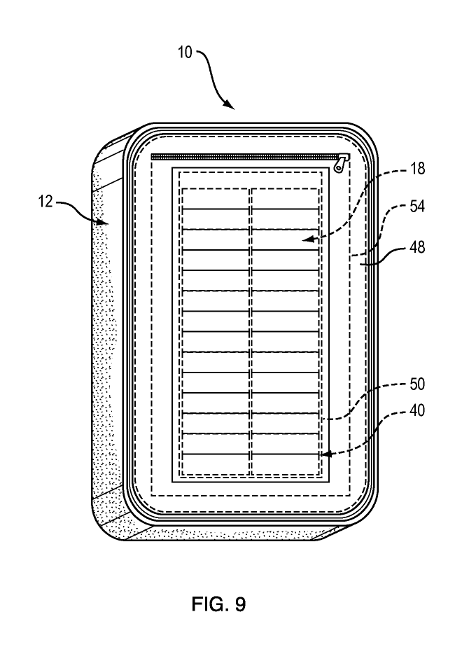

FIG. 9 shows another exemplary pet bed 10 for providing a cooled and/or heated surface upon which a pet can rest. The pet bed 10 can include the base portion 12, the top portion 14, the fastening device 16, and pack insert 18. In the present embodiment, the interior area 50 can have a generally rectangular configuration having a perimeter 54 that is substantially equal to or slightly smaller than the perimeter 48 associated with the top portion 14 so that the perimeters 54 and 48 generally coincide. In some embodiments, the compartment 40 can be defined by the perimeter 48 of the top portion 14 such that the perimeter 48 and 54 are one and the same. The pack insert 18 can be dimensioned to generally coincide with the perimeter 48 so that the pack insert 18 extends over a substantial portion of the top portion 14 to provide an area of cooling or heating that generally coincides with a surface area of the top portion 14.

Embodiments of the pet bed 10 described herein provide a flexible for providing a comfortable surfaces upon which a pet can rest. For example, the base portion 12 and the top portion 14 can each be used separately and can be used together, where the top portion 14 can retain the thermal pack insert 18. Using the thermal pack insert 18, the pet bed 10 can provide a cooled, heated, and/or maintained temperature and/or temperature range to promote a thermal energy transfer between the pet and the pet bed to cool, heat, and/or maintain a temperature of the pet. Additionally, the including a separable base portion 12 and top portion 14 and having the removable thermal pack insert 18 allows the each portion to be cleaned or washed separately.

While preferred embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

What is claimed is:

1. A pet bed comprising:
a base portion including an outer shell defining a cavity and a fill material disposed within the cavity of the outer shell;
a top portion detachably fastened to the base portion, the top portion including a closable compartment defining an interior area within the top portion; and
a thermal pack insert capable of fitting within the interior area defined by the closable compartment, the thermal pack insert configured to heat, cool, or maintain a temperature associated with the top portion.

2. The pet bed of claim 1, wherein the closable compartment comprises a sleeve disposed between a first surface and a second surface of the top portion, the sleeve having an opening at a first end and being closed at a second end, the opening being closable using a closure device disposed with respect to the opening.

3. The pet bed of claim 1, wherein the top portion includes first and second surfaces operatively coupled to each other about a first perimeter of the first surface and a second perimeter of the second surface, and wherein the closable compartment is disposed between the first and second surfaces.

4. The pet bed of claim 3, wherein the compartment defines a third perimeter, the third perimeter being smaller than the first and second perimeters.

5. The pet bed of claim 3, wherein the closable compartment includes an opening formed in the first surface and a closure device associated with the opening to open and close the opening, wherein the interior area defined by the closable compartment is accessible when the opening is open and the interior area defined by the closable compartment inaccessible when the opening is closed.

6. The pet bed of claim 5, wherein the first surface is dimensioned and configured to support a pet and the second surface is dimensioned and configured to face towards and be proximate to the base portion when the top portion is fastened to the base portion.

7. The pet bed of claim 5, wherein the second surface of the top portion is inaccessible when the top portion is fastened to the base portion.

8. The pet bed of claim 1, further comprising a fastening device to detachably fasten the top portion to the base portion.

9. The pet bed of claim 9, wherein a first portion of the fastening device is disposed with respect to a perimeter of the top portion and a second portion of the fastening device is disposed with respect to a perimeter of a first surface of the base portion.

10. The pet bed of claim 9, wherein the first surface of the base portion includes a connecting material that forms a frame about the perimeter of the first surface of the base portion, the second portion of the fastening device being disposed on the connecting material.

11. The pet bed of claim 1, wherein the outer shell is nylon and the fill material is Poly-Fill.

12. The pet bed of claim 11, wherein at least a portion of the outer shell is coated with a water resistant material.

13. The pet bed of claim 1, wherein the closable compartment is centered within the top portion.

14. The pet bed of claim 1, wherein the top portion comprises a mesh material to promote air circulation.

15. The pet bed of claim 1, wherein the top portion is formed of a plurality of layers of one or more materials.

16. A pet bed comprising:
a base portion having a first surface, a second surface, and at least one side surface extending between the first and second surfaces to form a cavity within which a fill material is disposed;
a top portion being detachably fastened to the first surface, the top portion having third and fourth surfaces and a compartment disposed between the third and fourth surfaces for receiving a thermal pack insert; and
a fastening device to detachably fasten the top portion to the first surface of the base portion.

17. The pet bed of claim 16, wherein the compartment includes a closeable opening formed in one of the third surface and the fourth surface, the closeable opening having an open position to permit access to the interior area defined by the compartment and a closed position to restrict access to the interior area defined by the compartment.

18. The pet bed of claim 17, wherein the closeable opening is formed in the fourth surface and the fourth surface is positioned adjacent to the first surface when the top portion is fastened to the first surface so that the closeable opening is inaccessible when the top portion is fastened to the first surface.

19. The pet bed of claim 17, wherein the closeable opening is formed in the third surface and the third surface is positioned to provide a surface upon which a pet rests when the top portion is fastened to the first surface so that the closeable opening is accessible when the top portion is fastened to the first surface.

20. The pet bed of claim 16, wherein the top portion is detachable from the first surface, the first surface providing a surface upon which the pet rests when the top portion is detached.
